(19) United States
(12) Patent Application Publication
(10) Pub. No.: US 2021/0101304 A1
(43) Pub. Date: Apr. 8, 2021

(54) REMOVABLY MOUNTABLE ABNORMAL MOTION DETECTION DEVICE AND SAFETY FEATURE ENGAGEMENT TOOL

(71) Applicant: LANTERN HOLDINGS, LLC, Sterling, VA (US)

(72) Inventors: Chad Thomas GREEN, Sterling, VA (US); Joshua David WILLIS, Sterling, VA (US)

(73) Assignee: LANTERN HOLDINGS, LLC, Sterling, VA (US)

(21) Appl. No.: 17/060,807

(22) Filed: Oct. 1, 2020

Related U.S. Application Data
(60) Provisional application No. 62/910,228, filed on Oct. 3, 2019.

(51) Int. Cl. B27B 17/08; G06N 20/00; G06N 5/04

(52) U.S. Cl. CPC B27B 17/083; G06N 5/04; G06N 20/00

(57) ABSTRACT

A removably mountable abnormal motion detection device for abnormal motion detection of a power tool that includes a reactive device and a control device. The control device includes an abnormal detection system that utilizes a processor, one or more sensors; and a machine learning model trained to determine abnormal motion for the power tool. When it is determined by the control device that an abnormal motion has occurred or is about to occur in the near future, the control device communicates with the reactive device to engage a safety feature of the power tool.

### CROSS-REFERENCE TO RELATED APPLICATIONS

This application claims the benefit under 35 U.S.C. § 119(e) of the filing date of U.S. Patent Application No. 62/910,228, which was filed on Oct. 3, 2019 and which is incorporated here by reference.

### BACKGROUND

The embodiments of the present invention relate to the integration of a machine learning model with a motion detection system for use in power tools, e.g. chainsaws, that is removably mountable onto the power tool and works in conjunction with the power tool's safety features to engage one or more safety features of the power tool when an abnormal motion is detected.

In operation, power tools can be dangerous for users, especially when unwanted abnormal and unexpected motion from the power tools occurs. Abnormal motion includes any relative motion between the user and the power tool that may create contact between any portion of the user and any dangerous surface of the power tool causing impingement, laceration, or otherwise physical harm the user. For example, a user may experience kickback from a power tool. Kickback is a sudden, unexpected, forceful recoil from a power tool that occurs during use. This movement often happens when a moving blade of the power tool gets bound or pinched in a workpiece causing the power tool to lurch back toward the power tool user's body. Additionally, a user may unintentionally contact a moveable surface of any power tool as a result of fatigue or distraction.

Conventional power tool safety features may not engage in sufficient time to avoid injuries by a user when an abnormal motion occurs in the power tool. For example, in a typical kickback scenario, a chainsaw is held horizontally with the chain blade spinning in a vertical plane. When the upper front tip (referred to as the kickback corner) of the chainsaw becomes impinged or gains purchase in the material, the blade is forced vertically in the same plane of rotation as the chain. Conventionally, an inertial sensor is used to sense the rapid inertial acceleration due to the kickback event. Inertial sensors trip most easily in this vertical plane as gravity helps to trigger the brake. However, the user may occasionally choose to rotate the chainsaw in any horizontal or vertical orientation. Though it is discouraged, tree pruners often work overhead with the saw in one hand. A common kickback scenario in this orientation is called “climbing kickback”. The chainsaw is oriented vertically on a vertical tree trunk during pruning when the bottom edge of the chainsaw gets snagged and the chainsaw “climbs” the trunk very near the operator's face. Conventional inertial sensors are least effective in this dangerous vertical orientation.

The embodiments of the present invention improve the safety to a user of a power tool by using a machine learning model to determine whether abnormal motion of the power tool has occurred or is about to occur and actively engage the power tool's safety features.

### SUMMARY

The present invention relates to the integration of the motion detection system into a power tool with specific embodiments directed to a chainsaw, either internally to the housing, or externally in a reactive device that can be removably mountable to the handle of the chainsaw and includes a mechanical actuator to automatically trip a hand brake of the chainsaw when abnormal motion is detected.

Embodiments of the present invention include a high-precision, low false alarm rate detection apparatus, system, and method for rapid reaction to abnormal motion between a power tool and user, including sudden kinetic impulses caused by abnormal motion of a power tool. These technologies generally involve systems for measuring the total kinematic motion of any power tool, using a machine learning model to determine whether abnormal motion has occurred or is about to occur (imminent) given particular kinematic motion for a power tool, and engaging a reactive interlock, in this case an actuator for tripping the hand brake of a chainsaw, when the machine learning model determines that abnormal motion has occurred to inhibit further uncharacteristic motion from the power tool.

The machine learning model that allows for prediction of an abnormal motion is modeled to a specific power tool such as a chainsaw and can then be integrated into a removably mountable device that can quickly engage with one or more safety systems of the power tool, such as a hand brake of a chainsaw, upon determination that an abnormal motion is about to occur. Thus, improving safety to the user of the power tool.

### BRIEF DESCRIPTION OF THE DRAWINGS

FIG. 1 illustrates an abnormal motion detection device according to embodiments of the present invention.

FIG. 2 illustrates an exemplary abnormal motion detection system.

FIG. 3A-3D illustrates a reactive device and control box of the abnormal motion detection device according to embodiments of the present invention.

FIG. 4 illustrates a side view of a chainsaw including an abnormal motion detection device according to embodiments of the present invention.

Like reference numbers and designations in the various drawings indicate like elements.

### DETAILED DESCRIPTION

Embodiments of the present invention utilize machine learning modeling with a removably mountable reactive device that can engage safety features of a power tool and can be used in various power tools. Specific embodiments of the present invention are described below with respect to a chainsaw.

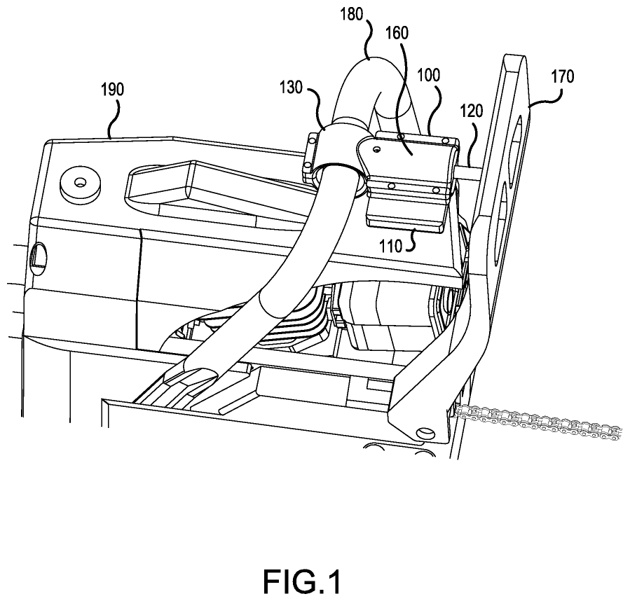

FIG. 1 is an illustration of one embodiment of the abnormal motion detection device 100 for chainsaws with an integrated actuating piston 120 and control box 110 which contains one or more sensors and processor. The device being removably mountable to a handle 180 of the chainsaw 190 using a securing mechanism 130.

Chainsaws, especially gas-powered chainsaws, have one of the highest vibration profiles of hand-held power tools. Many chainsaws include a chain brake system to stop the chain under certain conditions. As illustrated in FIG. 1, the chain brake system includes a hand brake 170 located on the exterior of the chainsaw 190 near the handle 180. When the hand brake 170 is in the off position, the tool is free to operate. When the hand brake 170 is tripped (set to the on position), it engages the chain brake system. For example, the chain brake system may include removing the energy source to the chain drive of the chainsaw 190 and applying a mechanical brake to rapidly stop the motion of the chain. There are several variations of the chain brake system from various manufacturers, but all are mechanical and rely on either contact between the hand brake 170 and the user (hitting a mechanical lever near the front or rear handle 180) or a significant inertial event to trip the chain brake.

Kickback can occur in various scenarios when using a chainsaw 190. When kickback occurs, the hand brake 170 is designed to make contact with a user during the kickback event. In order for the hand brake 170 to make contact with the user, the chainsaw must rotate towards the user such that the user is already in significant danger before the hand brake 170 is engaged. If the user's hand is misplaced on the handle 180 or the user is holding the chainsaw at an unusual angle, then there is a significant risk that contact will not be made with the hand brake 170 or that contact with the hand brake 170 will be made too late. However, with the use of the abnormal motion detection device 100, user contact with the hand brake 170 is not required. In embodiments of the present invention, imminent kickback events may be predicted prior to the actual kickback event, automatically engaging the hand brake 170 and significantly reducing risk to the user. Thus, harm to the user is much less likely to occur.

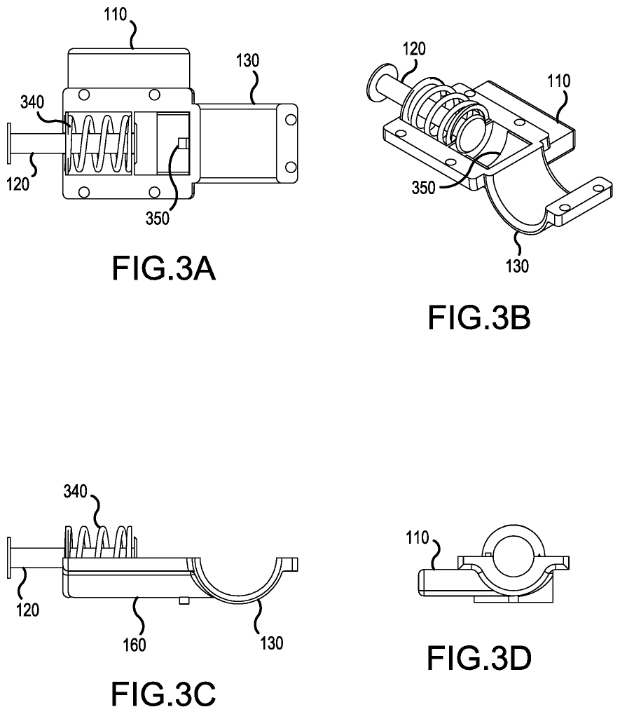

As shown in FIG. 1, the abnormal motion detection device 100 is securely attached to the chainsaw handle 180 using the securing mechanism 130 and also includes the casing 160 and has attached thereto a control box 110. However, the control box 110 may be located separately. The securing mechanism 130 may be any type of mechanism that secures the abnormal motion detection device 100 to the chainsaw 190. In this embodiment, the securing mechanism 130 is formed in a similar shape to the handle 180 such that it wraps around the handle 180 and is fastened thereto by screws or other locking feature. The casing 160 may be any shape and size such that it allows for internal construction such as shown in FIGS. 3A-3D and described below. In this embodiment, the casing 160 is a cylindrical shape.

In the depiction of FIG. 1, the hand brake 170 of chainsaw 190 is in the ON (engaged) position, and the actuating piston 120 is fully extended to its forward position. Thus, the piston 120 when in its fully extended position, has engaged with the hand brake 170 to initiate the engagement of the hand brake 170 in the ON (engaged) position.

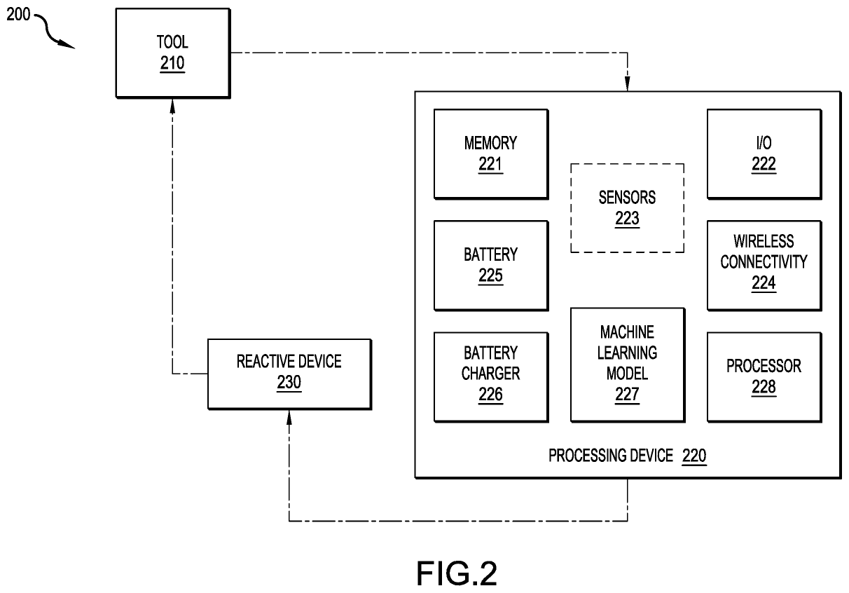

FIG. 2 illustrates an embodiment of an abnormal detection system 200 that may be used when integrated within a removably mountable abnormal detection device 100. The abnormal motion detection system 200 monitors motion of a power tool 210 while in use by a user and gathers sensor data from multiple sensors 223, and processes the sensor data with a processing device 220. The processing device 220 may be housed in a control box 110 of the abnormal detection device 100, such as the control box 110 shown in FIGS. 3A-3D and located in an abnormal motion detection device 100 of the abnormal detection system 200.

In embodiments of the invention, the processing device 220 interfaces with a machine learning model 227 to determine whether abnormal motion has occurred or is about to occur. This is achieved with the use of a machine learning model architecture designed for time sequence forecasting, such as a recurrent neural network, including but not limited to a Long Short-Term Memory (LSTM) network. The machine learning model 227 receives a continuous sequence of sensor data which may be comprised of inertial data, tool speed, torque of the tool motor, throttle position, and other environmental inputs. The data is captured at periodic intervals and collated into a unified frame with a timestamp. Each frame of data is added to a processing pipeline in a sequence such that the sequence is continuous. With each new frame of data, the machine learning model 227 forecasts what data is most likely to be present in future subsequent data frames. In embodiments such as sequence to sequence forecasting the machine learning model 227 takes a sequence of current and past frames to predict a sequence of future frames. Once forecasting is complete, the probability of abnormal motion is calculated based on the sequence of past, present, and future data frames. Thus the machine learning model 227 is able to predict the probability of abnormal motion such as kickback occuring in the near future and preemptively mitigate the hazard of abnormal motion such as kickback. Further details of the machine learning model 227 used in embodiments of the present invention are found in U.S. application Ser. No. 16/878,975, which is hereby incorporated by reference.

As illustrated in FIG. 2, the processing device 220 includes a processor 228, memory 221, a data input output 222, and sensors 223. The processing device 220 may include a battery 225 and battery charger 226 or it may also be powered by external electrical power. It may include wireless connectivity capabilities 224 and a machine learning model 227 that is trained to predict abnormal motion of a power tool.

The processor 228 controls all software functions of the processing device 220. It receives data from the data input output functions 222 and runs computations such as processing data through the machine learning model 227.

The memory 221 stores both long-term and short-term data associated with particular processing tasks related to the processor and system. For example, the memory 221 may store information about respective tools. It may also store real-time sensor data which is buffered in anticipation of being processed through the machine learning model 227.

The sensor data, e.g, motion data from one or more sensors, can be sent wirelessly or using a wire to the processing device 224. In some embodiments, the sensor data is collected using a sensor that is located on the same circuit board as the processing device 220. In other embodiments, the system 200 relies on wireless or wired network capabilities of the sensors to send the data directly to the processing device 220.

When the processing device 220 determines that abnormal motion has occurred or is imminent, the processing device 220 notifies the reactive device 230, such as the actuating piston 120 which engages the safety feature of the power tool 210, such as the hand brake 170.

The reactive device 230 may be a device similar to the embodiments described herein as described in FIGS. 1 and 3A-3D. In embodiments of the present invention when the abnormal motion detection device 100 determines a kickback event, the reactive device 230, such as the actuating piston 120, is deployed by releasing a latch 350, which releases an energy source, such as a spring 340. The actuating piston 120 then deploys to push on the hand brake 170 of the chainsaw 190 which engages one or more standard safety features of the chainsaw 190. Once the hand brake 170 is engaged, the chainsaw power is cut off and the chainsaw 190 ceases operating.

In the absence of an electric motor, an additional sensor may be required to measure the mechanical motion, including but limited to torque, of the combustion engine in order for it to be sensed and added to the detection algorithms such as a machine learning model 227. Also, an electromechanical actuator to trigger the safety feature of the power tool may be required.

FIGS. 3A-3D are illustrations of an embodiment of the abnormal motion detection device 100 and control box 110 which houses the abnormal motion detection system 200. As shown in FIGS. 3A-3D, the casing 160 supports internal mechanisms that include an energy source, which as shown in this embodiment may be a mechanical spring 340, however the energy source may be comprised of a pneumatic cylinder, gas chamber with ignition source, electro-mechanical solenoid, mechanically or electrically initiated propellant such as black powder contained in a munition cartridge, or other energetic device. The energy source may be secured in the casing 160 in any manner appropriate for the energy source. In some embodiments, the casing 160 can be accessible to allow for changing of the energy source should that be necessary or desired.

In this embodiment, the spring 340 is compressed by the action of the user pulling the hand brake 170 to the OFF position which pushes on the actuating piston 120 such that the actuating piston 120 is moved to a ready position where it is not fully extended which also loads the spring 340. The spring is locked in place by the latch 350. The actuating piston 120 is now in the ready position in anticipation of an abnormal motion event.

When abnormal motion is determined by the processing device 220, a signal is sent to release the latch 350, causing all the stored energy in the spring 340 to be transferred to forward motion of the actuating piston 120. The actuating piston 120 transfers its forward motion to the hand brake 170 of the chainsaw 190 which engages one or more standard safety features or systems of the chainsaw 190.

In embodiments of the invention, the actuating piston 120 is attached to the hand brake 170. In other embodiments, the actuating piston 120 is not attached to the hand brake 170. In embodiments where the actuating piston 120 is not attached to the hand brake 170, it is preferable that the actuating piston 120 be in close proximity to the hand brake 170 to provide for quicker engagement in the event the actuating piston 120 is released and avoiding interference between the actuating piston 120 and hand brake 170 by other elements including human body parts. However, the actuating piston 120 can be set at any distance between the hand brake 170 that enables responsive engagement of the hand brake 170.

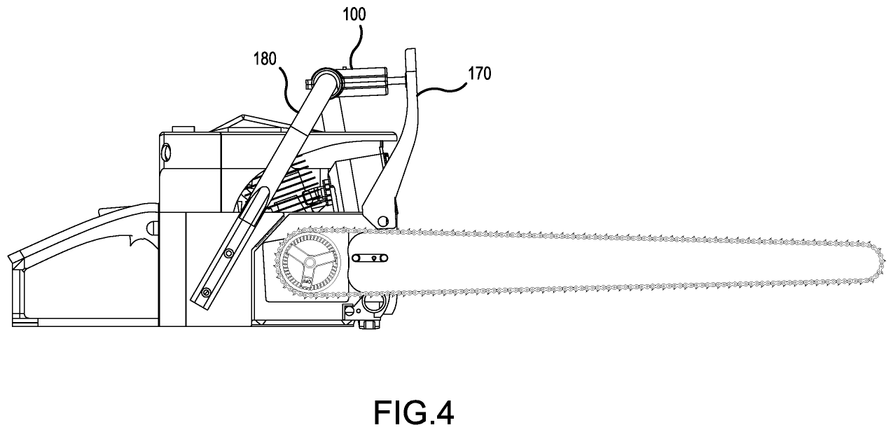

FIG. 4 is an illustration of an embodiment of the present invention illustrating an overall side view of a chainsaw 190 with the abnormal motion detection device 100 attached to the handle 180 in a position at the top of the handle 180 to directly engage the hand brake 170. However, the abnormal motion detection device 100 can be located at any position of the handle that allows for it to engage directly with the hand brake 170.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more memory devices for storing data. However, a computer need not have such devices.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

What is claimed is:

1. A removably mountable abnormal motion detection device for abnormal motion detection of a power tool comprising:
a reactive device and a processing device;
the processing device including:
a processor;
one or more sensors; and
a machine learning model trained to predict abnormal motion for the power tool;
a securing mechanism to secure the abnormal motion detection device to the power tool;
an energy source that engages with the reactive device;
wherein when the processing device predicts that an abnormal motion is about to occur, the processing device communicates with the reactive device to engage a safety feature of said power tool.

2. The removably mountable abnormal motion detection device of claim 1, wherein the power tool is a chainsaw.

3. The removably mountable abnormal motion detection device of claim 2, wherein the safety feature of the chainsaw is a hand brake.

4. The removably mountable abnormal motion detection device of claim 3, wherein the reactive device is an actuating piston and engages with the hand brake when abnormal motion is predicted to move the hand brake to an ON position.

5. The removably mountable abnormal motion detection device of claim 1, wherein the energy source is a mechanical spring.

6. The removably mountable abnormal motion detection device of claim 1, wherein the energy source is one of, a pneumatic cylinder, gas chamber with ignition source, electro-mechanical solenoid, or mechanically or electrically initiated propellant.

7. The removably mountable abnormal motion detection device of claim 4, wherein the actuating piston is attached to the hand brake.

8. The removably mountable abnormal motion detection device of claim 1, wherein the one or more sensors include at least one or more of a three-axes accelerometer sensor; a three-axes gyroscope sensor; and a three-axes magnetometer sensor.

9. A removably mountable abnormal motion detection system for abnormal motion detection of a power tool comprising:
a reactive device secured to the power tool in a manner to directly engage with a safety feature of the power tool; and
a processing device, comprising:
a processor;
one or more sensors; and
a machine learning model trained to determine abnormal motion of the power tool;
wherein the processor is configured to receive data from the one or more sensors and the machine learning model to predict when an abnormal motion is about to occur and communicate with the reactive device to engage the safety feature of said power tool.
